(19) United States
(12) Patent Application Publication
(10) Pub. No.: US 2015/0200889 A1
(43) Pub. Date: Jul. 16, 2015

(54) SYSTEM AND METHOD FOR SENDING MESSAGES

(71) Applicant: Heysnap Ltd., Ramat Hasharon (IL)

(72) Inventor: Elad HEMAR, Tel Aviv (IL)

(21) Appl. No.: 14/341,852

(22) Filed: Jul. 28, 2014

Related U.S. Application Data
(60) Provisional application No. 61/964,791, filed on Jan. 15, 2014.

(51) Int. Cl. H04L 12/58; G06F 3/0484

(52) U.S. Cl. CPC H04L 51/10; G06F 3/04842

(57) ABSTRACT

An interactive layer includes a layer presenter to present the layer over a viewing screen, when the screen is displaying an item. The layer includes at least one creatable input mechanism representing a recipient and a platform of communication, a handler to receive and handle an instruction to send the item when the input mechanism receives an activation and a distributer to distribute the item to the recipient via the platform of communication. A device includes an input handler to instruct an imaging unit of the device to take an image when an input mechanism is touched and a distributer to distribute the image to the recipient via the platform of communication. A system for adding an icon to a shared image.

### CROSS-REFERENCE TO RELATED APPLICATIONS

This application claims priority from U.S. Provisional Patent Application No.

61/964,791 filed 15 Jan. 2014 which is hereby incorporated in its entirety by reference.

### FIELD OF THE INVENTION

The present invention relates to messaging generally and to pictures in particular.

### BACKGROUND OF THE INVENTION

With the onset of mobile communication devices, we now have the technology at our finger tips wherever we are with the ability to communicate almost instantly.

Almost all smart mobile communication devices such as mobile phones and tablets provide the ability to take photographs to capture moments and to share them.

Social media has also given us the opportunities to create, share or exchange information and ideas over virtual communities and networks as well as opportunities to comment and remark on shared items such as the Facebook “like” button.

### SUMMARY OF THE PRESENT INVENTION

There is provided in accordance with a preferred embodiment of the present invention, a device including an input mechanism to receive a touch; an input handler to instruct an imaging unit of the device to take an image when the input mechanism is touched and a distributer to distribute the image according to pre-defined attributes associated with the input mechanism when the input mechanism is released.

Moreover, in accordance with a preferred embodiment of the present invention, the device also includes configurer to configure the input mechanism.

Further, in accordance with a preferred embodiment of the present invention, the device also includes a layer presenter to present an interaction layer over the viewer screen of the imaging unit and to present the input mechanism.

Still further, in accordance with a preferred embodiment of the present invention, the input mechanism is a button.

Additionally, in accordance with a preferred embodiment of the present invention the pre-defined attributes are at least one of target recipient and mode of communication.

Moreover, in accordance with a preferred embodiment of the present invention, the target recipient is at least one of a local contact, a contact from a social network, unknown to the user of the device, a social network, a feed, a physical instruction and a group defined by geographical location.

Further, in accordance with a preferred embodiment of the present invention, the mode of communication is at least one of an SMS, a MMS, an email and via a social network.

Still further, in accordance with a preferred embodiment of the present invention, the input handler includes an effect adder to add an effect to the image.

Additionally, in accordance with a preferred embodiment of the present invention, the effect is at least one of filtering color, adding animation, adding text, adding an icon, adding visual media type and creating a disappearing image.

Moreover, in accordance with a preferred embodiment of the present invention, the touch is at least one of a tap and swipe.

There is provided in accordance with a preferred embodiment of the present invention, an interactive layer implementable on a communication device. The interactive layer includes a layer presenter to present the layer over a viewing screen of the communication device when the screen is displaying an item; at least one creatable input mechanism representing a recipient and a platform of communication; a handler to receive and handle an instruction to send the item when the input mechanism receives an activation and a distributer to distribute the item to the recipient via the platform of communication.

Moreover, in accordance with a preferred embodiment of the present invention, the interactive layer also includes pre-configured control buttons.

Further, in accordance with a preferred embodiment of the present invention, the item is at least one of a single image, multiple images, text, documents, sound, video and icons.

Additionally, in accordance with a preferred embodiment of the present invention, the handler includes a retriever to retrieve the item from its source.

Moreover, in accordance with a preferred embodiment of the present invention, the layer presenter includes a displayer to display over part of the viewing screen of the device.

Further, in accordance with a preferred embodiment of the present invention, the layer is at least one of transparent and translucent.

Still further, in accordance with a preferred embodiment of the present invention, the interactive layer includes an icon adder to add an icon displayed by the creatable input mechanism to a secondary layer when the input mechanism is activated and to present the secondary layer over the interactive layer and the item.

Still further, in accordance with a preferred embodiment of the present invention, the activation is at least one of a tap, a swipe, a double tap, a tap without hold and a tap with hold.

There is provided in accordance with a preferred embodiment of the present invention, a system for adding an icon to a shared image. The system includes on a recipient side: a recipient receiver to receive the image from a sender and a layer presenter to present an interactive layer over the image and where the interactive layer receives a drawing drawn by a user on the interactive layer. The system also includes an interpreter to interpret the drawing as a pre-defined icon having an associated code; and a distributer to return the image to the sender with the matched code.

Moreover, in accordance with a preferred embodiment of the present invention, the system also includes on a sender side: a sender receiver to receive the image and the code returned by the distributer and a retriever to retrieve the icon from a local database according to the code. The system also includes an icon adder to add the retrieved icon to a secondary layer and to present the secondary layer over the image.

Further, in accordance with a preferred embodiment of the present invention, the interpreter includes an analyzer to analyze the x, y and z coordinates of the drawn animation.

Still further, in accordance with a preferred embodiment of the present invention, the interpreter includes a prioritizer to prioritize the analysis of the drawing.

There is provided in accordance with a preferred embodiment of the present invention, a method implementable on a computing device, the method includes: receiving a touch from an input mechanism; instructing an imaging unit of the device to take an image when the input mechanism is touched and distributing the image according to pre-defined attributes associated with the input mechanism when the input mechanism is released.

Moreover, in accordance with a preferred embodiment of the present invention, the method also includes configuring the input mechanism.

Further, in accordance with a preferred embodiment of the present invention, the method includes presenting an interaction layer over the viewer screen of the imaging unit and presenting the input mechanism.

Still further, in accordance with a preferred embodiment of the present invention, the input mechanism is a button.

Additionally, in accordance with a preferred embodiment of the present invention, the pre-defined attributes are at least one of target recipient and mode of communication.

Moreover, in accordance with a preferred embodiment of the present invention, the target recipient is at least one of a local contact, a contact from a social network, unknown to the user of the device, a social network, a feed, a physical instruction and a group defined by geographical location.

Further, in accordance with a preferred embodiment of the present invention, the mode of communication is at least one of an SMS, a MMS, an email and via a social network.

Still further, in accordance with a preferred embodiment of the present invention, the method also includes adding an effect to the image.

Additionally, in accordance with a preferred embodiment of the present invention, the adding an effect is at least one of filtering color, adding animation, adding text, adding an icon, adding visual media type and creating a disappearing image.

Moreover, in accordance with a preferred embodiment of the present invention, the touch is at least one of tapping and swiping.

There is provided in accordance with a preferred embodiment of the present invention, a method implementable on a communication device. The method includes presenting a layer over a viewing screen of the communication device, with the screen displaying an item; representing a recipient and a platform of communication on a creatable input mechanism; receiving and handling an instruction to send the item when the input mechanism receives an activation and distributing the item to the recipient via the platform of communication.

Moreover, in accordance with a preferred embodiment of the present invention, the method also includes pre-configuring control buttons.

Further, in accordance with a preferred embodiment of the present invention the item is at least one of an image, multiple images, text, documents, sound, video and icons.

Still further, in accordance with a preferred embodiment of the present invention, the handling includes retrieving the item from its source.

Additionally, in accordance with a preferred embodiment of the present invention, the presenting includes displaying over part of the viewing screen of the device.

Moreover, in accordance with a preferred embodiment of the present invention, the method includes adding an icon displayed by the creatable input mechanism to a secondary layer when the input mechanism is activated and presenting the secondary layer over the interactive layer and the item.

Further, in accordance with a preferred embodiment of the present invention, the activation is at least one of tapping, swiping, double tapping, tapping without hold and tapping with hold.

There is provided in accordance with a preferred embodiment of the present invention, a method for adding an icon to a shared image. The method includes on a recipient side, receiving the image from a sender; presenting an interactive layer over the image, where the interactive layer receives a drawing drawn by a user on the interactive layer; interpreting the drawing as a pre-defined icon having an associated code and returning the image to the sender with the matched code.

Moreover, in accordance with a preferred embodiment of the present invention, the method also includes on a sender side, receiving the image and the code returned by the distributer, retrieving the icon from a local database according to the code and adding the retrieved icon to a secondary layer and presenting the secondary layer over the image.

Further, in accordance with a preferred embodiment of the present invention, the interpreting includes analyzing the x, y and z coordinates of the drawn animation.

Still further, in accordance with a preferred embodiment of the present invention, the interpreting includes prioritizing the analysis of the drawing.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a device for sending picture messages with a single tap, constructed and operative in accordance with the present invention;

FIG. 2 is a schematic illustration of a one tap photo sender, constructed and operative in accordance with the present invention;

FIGS. 3A and 3B are schematic illustrations of a smartphone with an interactive layer, constructed and operative in accordance with the present invention;

FIG. 4 is a schematic illustration of an alternative embodiment to the one tap photo sender of FIG. 2, constructed and operative in accordance with the present invention;

FIG. 5 is a schematic illustration of the smartphone of FIGS. 3A and 3B with an additional interactive layer, constructed and operative in accordance with the present invention;

FIGS. 6A, 6B and 6C are schematic illustrations of a configurer to configure the one tap sender of FIG. 2, constructed and operative in accordance with the present invention;

FIG. 7 is a schematic illustration of a system for enabling multiple buttons on an interactive layer, constructed and operative in accordance with the present invention;

FIG. 8 is a schematic illustration of a system for sharing photographs via a community of users with a single tap; constructed and operative in accordance with the present invention;

FIG. 9 is a schematic illustration of a system for sharing photographs with icons within a social network, constructed and operative in accordance with the present invention;

FIGS. 10A and 10B are schematic illustrations of the implementation of the system of FIG. 9 on a smartphone, constructed and operative in accordance with the present invention;

FIG. 10C is a schematic illustration of how to draw the icons for the system of FIG. 9;

FIG. 11 is a schematic illustration of an alternative implementation of the system of FIG. 9, constructed and operative in accordance with the present invention;

FIG. 12 is a schematic illustration of an alternative system for sharing photographs with icons within a social network, constructed and operative in accordance with the present invention and

FIG. 13 is a schematic illustration of a system for sending hidden photographs in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Current methods of sharing photographs entail taking the photograph, selecting the captured photograph, selecting the share option, selecting the mode of sharing and then selecting the recipient or recipients and then pressing the “send” button.

Applicants have realized that all of the above mentioned steps may be condensed into a method that entails a single tap process that may enable a user to tap on a button or any other form of input mechanism in order to take a photograph and automatically send it while remaining in the current view of the photograph, i.e. the single tap may take the photograph and the release of the finger may send it.

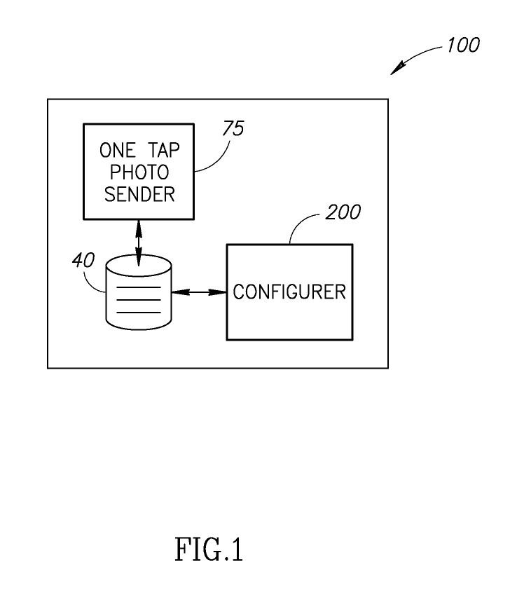

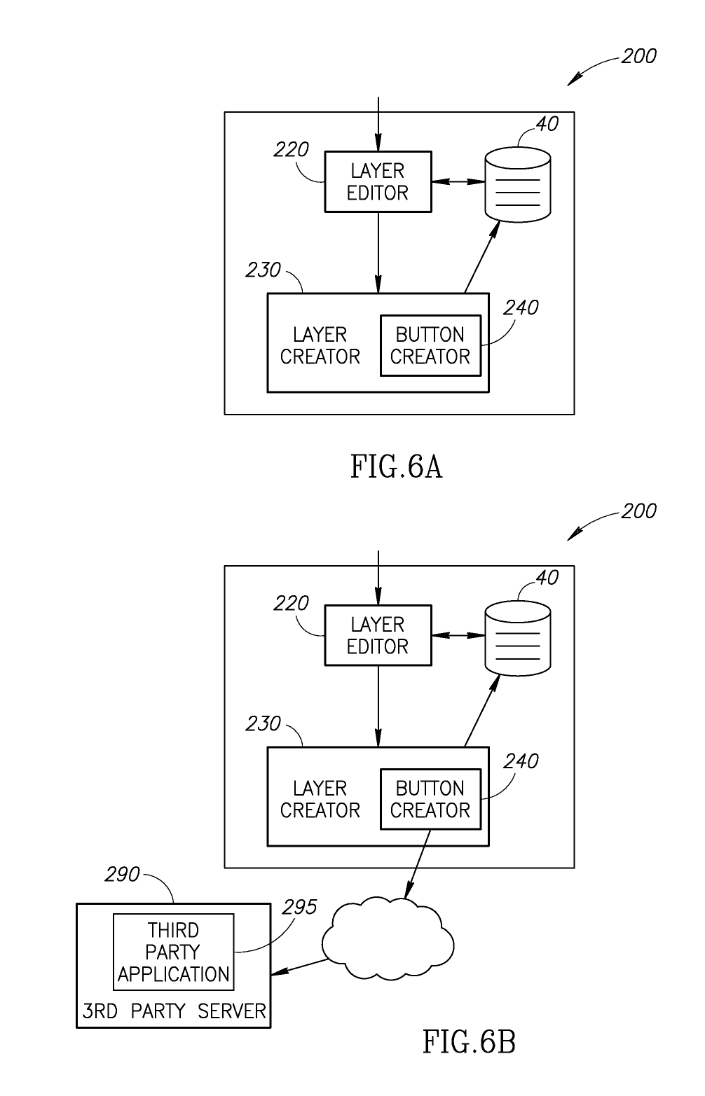

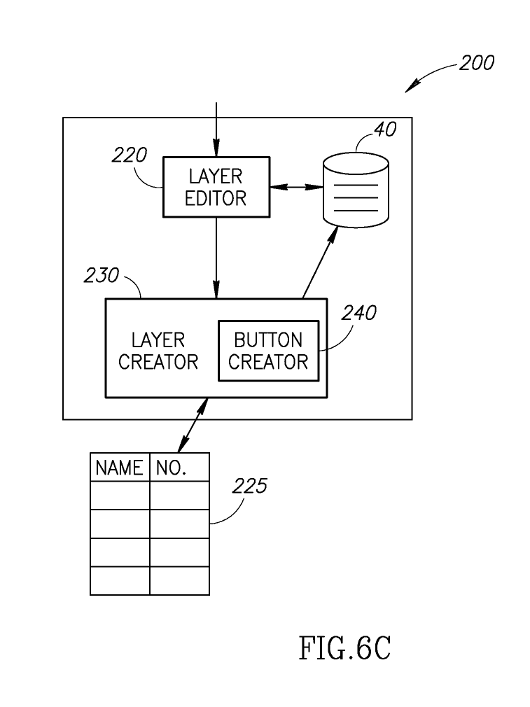

Reference is now made to FIG. 1 which illustrates a device 100 for sending picture messages with a single tap in accordance with an embodiment of the present invention. Device 100 comprises a one tap photo sender 75, a database 40 and a configurer 200. The functionality of configurer 200 is described below in relation to FIGS. 6A, 6B and 6C.

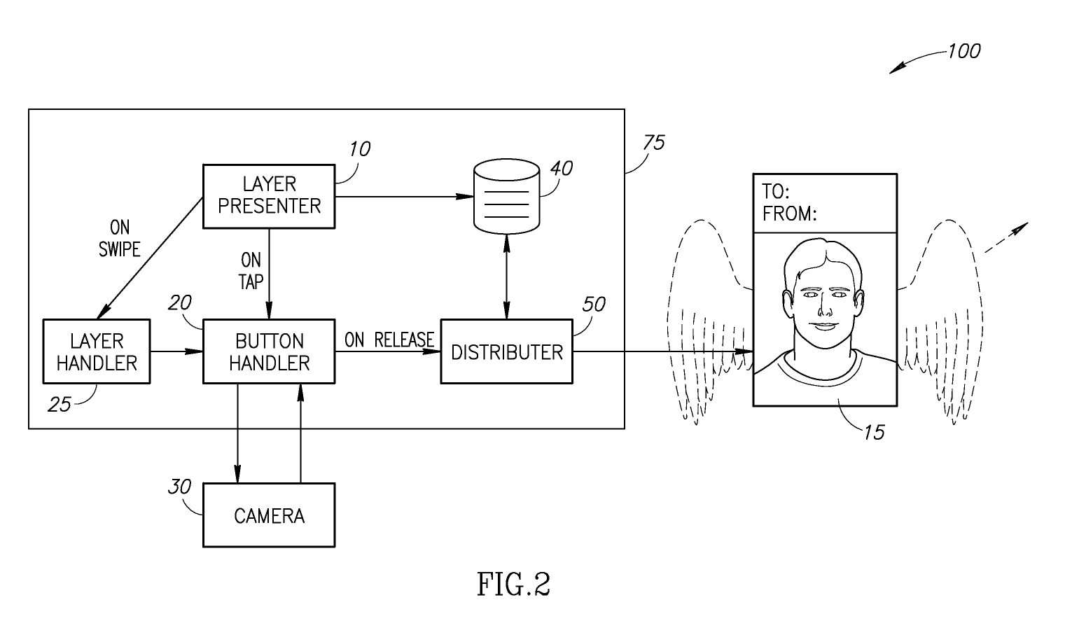

Reference is now made to FIG. 2 which illustrates the elements of one tap photo sender 75. One tap photo sender 75 comprises a layer presenter 10, a button handler 20, a layer handler 25 a database 40 and a distributer 50. One tap photo sender 75 may be used as an add-on to the local camera 30 of the pertinent device as described in more detail herein below

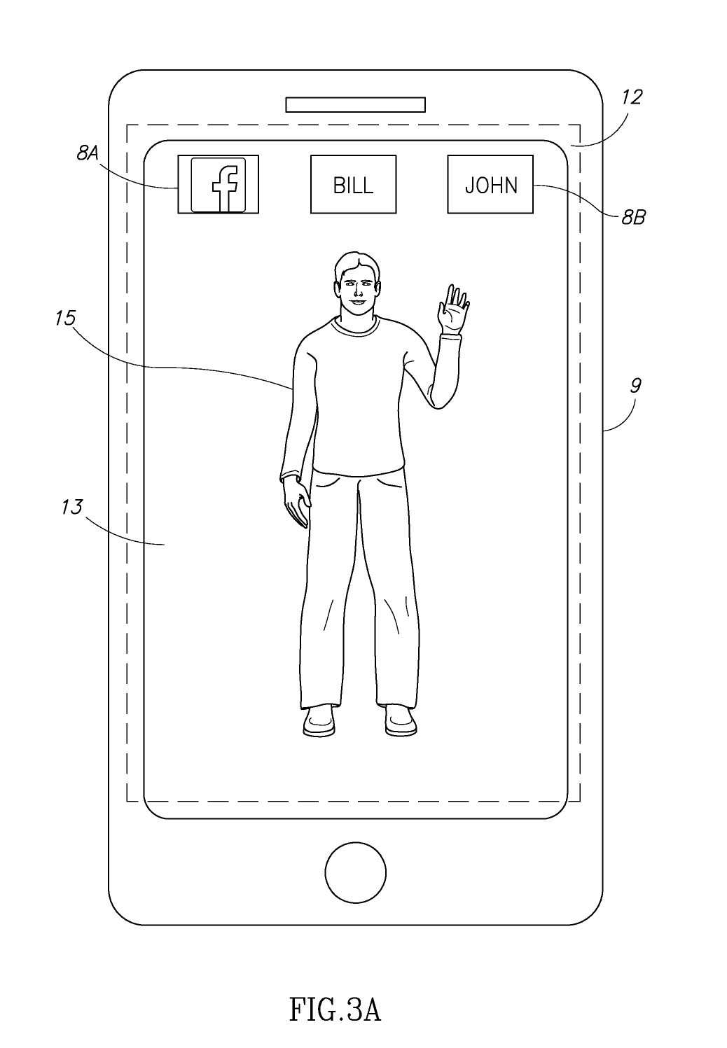

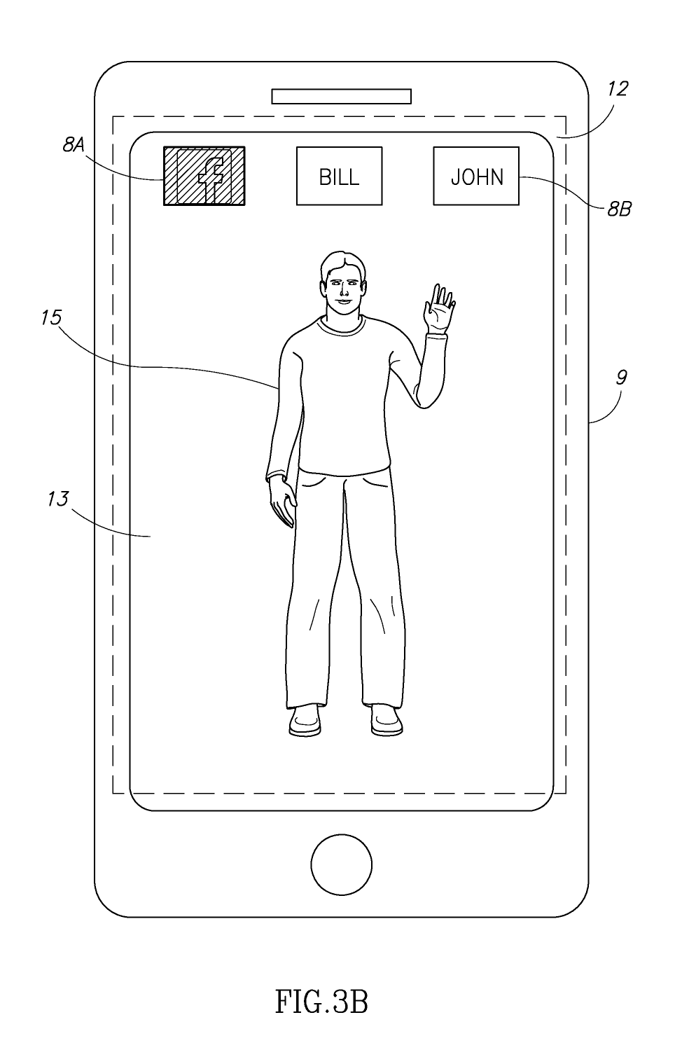

User 5 may enable camera 30 on for example, on a mobile communication device 9. Once camera 30 has been enabled, layer presenter 10 may present to user 5 an interactive layer 12 as is illustrated in FIGS. 3A and 3B to which reference is now made. It will be appreciated that interactive layer 12 may be considered a transparent layer appearing over the camera 30 presentation screen of the pertinent device. Interaction layer 12 may be also considered an interface between user 5 and device 100 and may present to user 5 buttons 8 representing recipients. FIGS. 3A and 3B illustrate a smartphone 9 with camera 30 enabled together with the presentation of an interaction layer 12. FIG. 3A illustrates an interaction layer 12 including buttons 8 as presented to a user before taking a photograph 15, FIG. 3B illustrates interaction layer 12 with an enabled button 8A. It will be further appreciated that in this manner, user 5 may see layer 12 as a transparent layer superimposed over the camera presentation screen 13. Camera presentation screen 13 may be considered the screen where the object or person to be photographed is viewed before photograph 15 is taken.

In an alternative embodiment, layer 12 may only partially cover camera presentation screen 13 such as the lower or upper half of the screen. In this scenario, user 5 may only see all the buttons in the upper or lower half of the screen. In yet another alternative embodiment, layer 12 may be translucent.

Button handler 20 may coordinate any activity concerning activation of buttons 8. Layer handler 25 may coordinate activity concerning direct touch contact with layer 12 not involving buttons 8.

User 5 may press one of the buttons 8 to enable it (8A) as is illustrated in FIG. 3B. Button handler 20 may be alerted to which button 8 has been pressed and may instruct camera 30 to take a photograph 15. Camera 30 may take photograph 15 and return the image to button handler 20. It will be appreciated that at this stage, user 5 may still be pressing down on button 8. If user 5 is not satisfied with photograph 15 as displayed on interaction layer 12, without removing his finger he may swipe his finger over layer 12 in order to discard photograph 15. It will be appreciated that on swiping, layer handler 25 may inform button handler 20 that the transaction has been cancelled. If user 5 is satisfied with photograph 15 and wishes to send it onwards, user 5 may lift his finger and release the pertinent button 8. On release, button handler 20 may then instruct distributer 50 to distribute photograph 15 accordingly as described in more detail herein below.

It will be appreciated that each button 8 may be pre-configured using configurer 200 as described in more detail below to a particular recipient and a mode of communication. For example, button 8A may be configured to send photograph 15 to Facebook and button 8B may be configured to send to John Smith via an SMS.

Distributer 50 may obtain details of the recipient and platform for sending for the pertinent button 8 from database 40 and may send off photograph 15 accordingly. Distributer 50 may also inform the recipient push provider that photograph has been sent so that recipient or target of photograph 15 may receive a push notification once photograph 15 has been received. Distributer 50 may also send a confirmation notification to user 5 that photograph 15 has been distributed.

It will be appreciated that an alternative gestures may be used instead of tapping and holding such as double tapping, tap without hold, swiping and holding, swiping in different directions, tap without edit, movement of button 8 etc. on both button 8 and on layer 12.

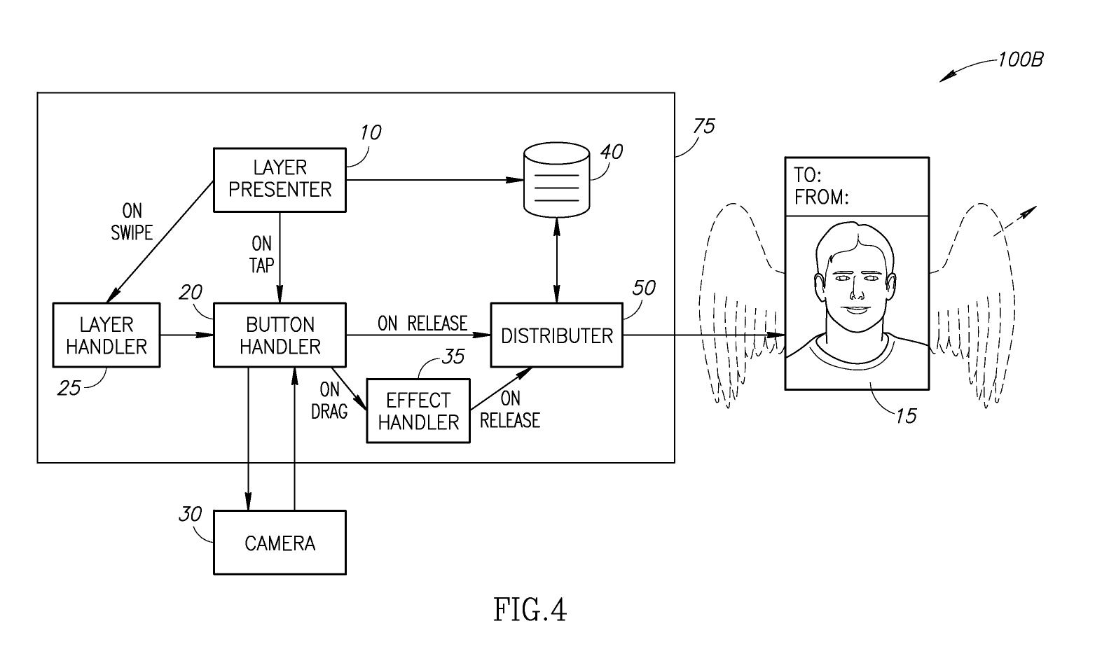

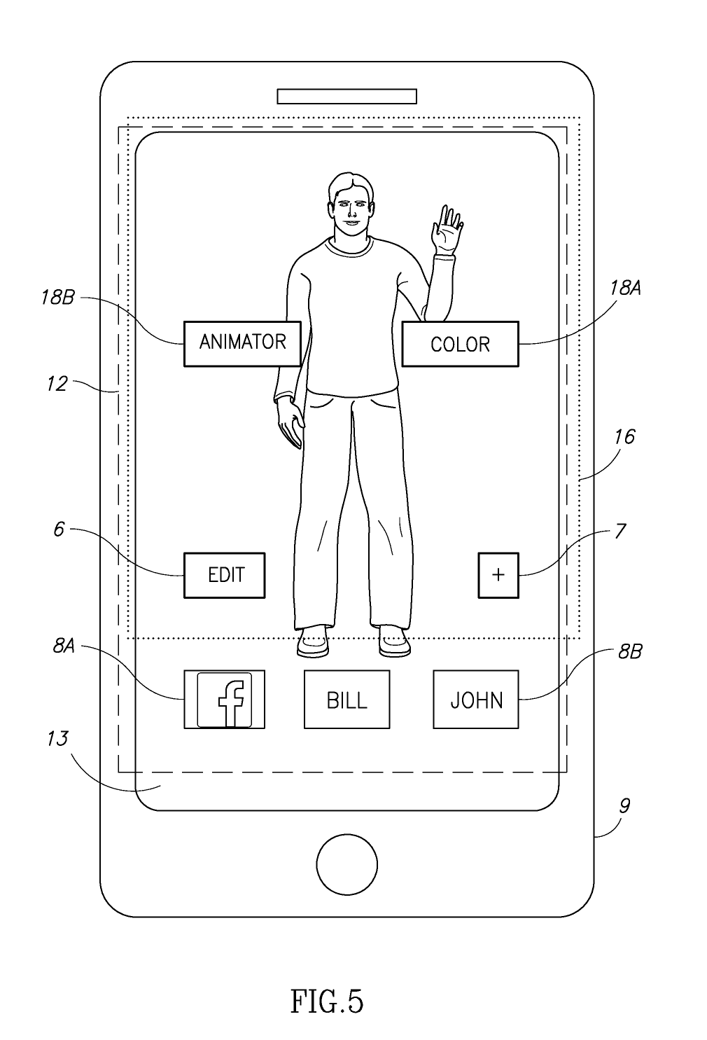

In an alternative embodiment system 100 may also comprise an effect handler 35 as illustrated in FIG. 4 to which reference is now made. User 5 may also add an effect to photograph 15 before sending it such as a color filter or may turn it into a disappearing or allowed to be seen once photograph. It will be appreciated that in this embodiment, layer presenter 10 may present to user 5 an additional layer 16 as seen in FIG. 5 to which reference is now made. It will be appreciated that layer 16 may be presented once user 5 has taken photograph 15 while he is still pressing down on the pertinent button 8. Layer 16 may be considered another yet transparent layer presented over camera presentation screen 13 comprising effect buttons 18. It will be appreciated that each effect button 18 may have a different effect. Before releasing his finger from button 8 so that distributer 50 may send the photograph, user 5 may drag his finger over to the pertinent effect button 18. In this scenario, effect handler 35 may add the appropriate effect. Effect handler 35 may then instruct distributer 50 to send the photograph as described herein above. It will be appreciated that effects may include filtering color, adding animation, text or any other icon or visual media type.

It will also be appreciated that in this embodiment, layer 16 may also present to user 5 an edit button 6 and a plus button (“+”) 7 to add new recipients. Additional buttons may also be presented such as incoming messages, alerts and notifications via the operating system of smartphone 9.

It will be appreciated that all photographs 15 taken together with any effects may also be saved on database 40.

It will be further appreciated that camera 30 may be used in both its back and forward modes in order to capture selfies etc.

Reference is now made to FIGS. 6A, 6B and 6C which illustrate the elements of system 200 for configuring interaction layer 12 in accordance with an embodiment of the present invention. System 200 comprises a layer editor 220 and interaction layer creator 230. Interaction layer creator 230 may further comprise a button creator 240.

Layer editor 220, via a suitable interface may receive new parameters for creating buttons 8 such as recipient name and/or ID and platform for sending such as email, SMS, MMS, email, social network etc. It will be appreciated that the appropriate parameters may be added according to the required platform, mobile number, email address etc.

Layer editor 220 may then pass these parameters to layer editor 230 and instruct layer creator 230 to create a layer 12 including any buttons 8 created by button creator 240 using the provided parameters. Once layer 12 has been created, it may be stored in database 40 for use during runtime as described herein above.

It will be appreciated that each button 8 presented may visually represent its recipient using a name, nickname, local photograph, a profile photograph from a social network, an associated icon or visual representation etc.

It will also be appreciated that recipients of photograph 15 may be contacts added from the local address book 225 of user 5 or from a social network of device 100 users as described in more detail herein below. In another embodiment, when the (“+”) 7 button is enabled on layer 16, contacts held locally in address book 225 may be presented for selection to user 5.

It will be further appreciated that during runtime, once a new button 8 is created using (“+”) 7 button, the new button 8 may be automatically added to and presented by layer 12.

In an alternative embodiment as is illustrated in FIG. 6B, button 8 may be configured with a third party application 295 such as Facebook sitting on an external third party server 290. It will be appreciated that in this scenario, distributer 50 may send photograph 15 to the home page of user 5 etc. In this scenario, the pertinent button 8 may show the logo of the relevant third party application. It will be appreciated that user 5 may also target an individual contact within a social network if there is an appropriate API available. In another embodiment, the recipient may be a feed belonging to user 5 or any accessible public feed.

It will be appreciated that user 5 may use edit button 6 to edit the current layer 12 when using layer 16 when presented. Edits may include the addition and/or deletion of buttons 8 to/from layer 12 or the rearrangement of the position of the buttons within layer 12. It will also be appreciated that when (“+”) 7 on layer 12 is enabled, layer editor 220 may receive parameters for a new recipient and forward them to button creator 240. Button creator 240 may then create the required individual buttons 8 accordingly. When edit button 6 is enabled, user 5 may delete buttons 8 by swiping them or by rearranging them by moving them with his finger. Layer editor 220 may forward any edits to layer creator 230 which may create a new updated version of layer 12 which may automatically replace the current version of layer 12 and save it on database 40 for use during runtime as described herein above.

It will be appreciated that the amount of buttons 8 that can be added to layer 12 may not be limited to the size of presentation screen 13. If the current view of layer 12 is full, user 5 may scroll layer 12 using his finger or any other navigation device horizontally or vertically, to present another view of layer 12 showing additional buttons 8.

In yet another embodiment, button creator 230 may be set to automatically create buttons according to log data held locally such as most 5 contacts most often contacted, or the last 5 contacts contacted as is illustrated in FIG. 6C to which reference is now made. FIG. 6C illustrates an automatic system 200B for configuring buttons in accordance with an embodiment of the present invention. It will be appreciated that in this scenario, button creator 230 may automatically receive its parameters from local address book 220 according to contact list access and information held by the local operating system.

In another embodiment, recipients may be according to public and/or geographical location. It will be appreciated that in this embodiment, device 100 may work in conjunction with the local GPS (global positioning system) to send to anyone located in a specified location or to a specific feed. It will be further appreciated that in this scenario, a pertinent button 8 may be configured to instruct distributor 50 to distribute photograph 15 to a particular public feed which may represent a location, a public event etc. Photograph 15 may therefore be seen by anyone looking for a photograph relevant to a specific location, event etc. It will be appreciated that in this scenario, the recipient of the photograph may not be known to user 5.

In yet another embodiment, the recipient may be a call for action, such as an instruction to send photograph 15 directly to a physical offline service provider such as a photograph development shop, or an instruction to send photograph 15 to a cloud target such as Dropbox commercially available from Dropbox Inc. or any other file storage system. Photograph 15 may also be sent to a target representing an individual, a website, a known individual, a web service, a commerce or e-commerce site and/or application or any business service online or offline

In a further embodiment, layer presenter 12 may use a known knowledge algorithm such as “Frequent Targets” and “Recent Targets” or any other algorithm that can calculate past, present and predicted usage to present different buttons 8 each time it is activated. In this scenario, layer editor 220 may retrieve the pertinent buttons 8 from database 40. For example the Frequent Target algorithm may be based on the frequency of communication with a recipient or target over a period of time. It may count the encounters and communication events between user 5 and a particular recipient and based on the results, layer 12, for example may present buttons 8 corresponding to most frequent contacts that user 5 has contacted. In an alternative embodiment, the most frequently contacted recipients may be grouped together under a single button 8 entitled (for example) “Favorites” so that photograph 15 may be sent the top 5 recipients together as described in more detail herein below. Alternatively, layer 12 may present buttons 8 corresponding to the last five contacts that user 5 has contacted.

It will be appreciated that device 100 may be installed locally as an add-on to the local camera 30 application or may be a third party application 290 accessed via an API. Device 100 may also be implemented as part of an operating system or as an application that is part of an operating system and pre-loaded. Device 100 may also be embedded within the hardware of the pertinent device. It will be further appreciated that device 100 may installed on any form of on line and off line communication device that receives touch input such as a computer, smart phone, tablet, camera, gaming console, interactive television, smart watch, wearable devices etc. Device 100 may also be implemented both through a web implementation (without a desk top client) with optional Java applet(s) or other downloadable or installable software components.

In an alternative embodiment, interactive layer 12 may be presented to user 5 after user 5 has taken photograph 15. It will be appreciated that in this scenario, the process of taking a photograph and distributing it further may entail more than one tap. For example, user 5 may take a photograph using the regular camera feature of the pertinent device. It will be appreciated that once the photograph has been captured, layer presenter 10 may present layer 12 containing the recipient buttons 8 and user 5 may select to whom he wishes to send the photograph and via which platform. Once user 5 has selected a recipient, button handler 20 may instruct distributor 50 to distribute the photograph as described herein above.

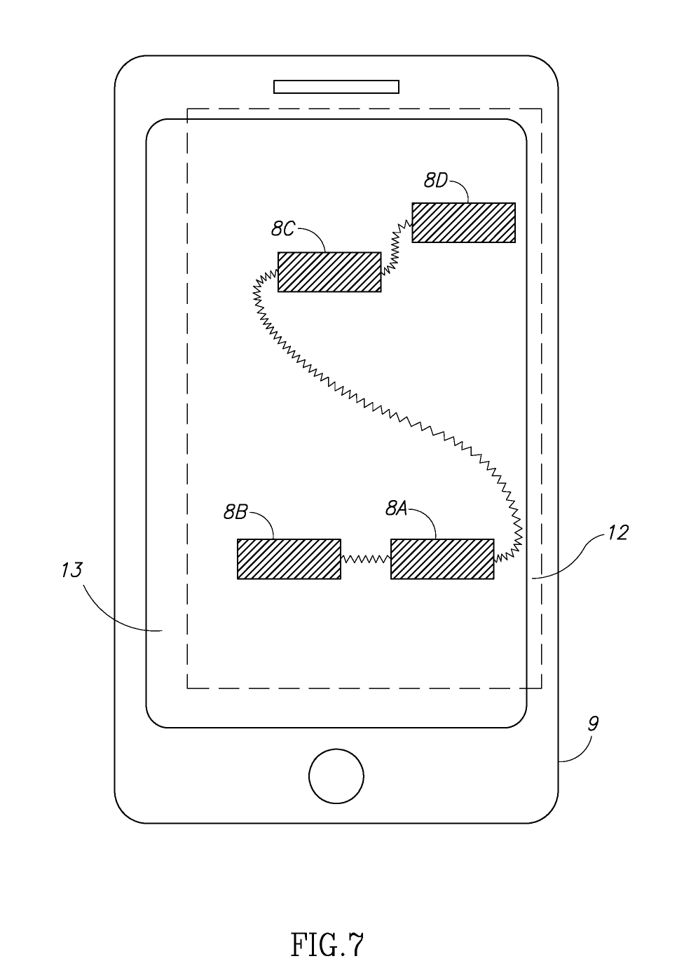

In yet another alternative embodiment, the same photograph may be sent to multiple recipients still using a single tap. In this embodiment, user 5 may tap a single button 8 and without releasing his finger, may then activate other buttons 8 by moving his finger over the screen (i.e. over interaction layer 12) with a snake like action until he has selected all the desired buttons as is illustrated in FIG. 7 to which reference is now made. Once he has released his finger, distributer 50 may distribute the photograph to each and every recipient as highlighted by the selected buttons 8.

In another embodiment, two different buttons 8 may be enabled at the same time by tapping them simultaneously (using more than one finger or input device). In this scenario, photograph 15 may be sent to both recipients simultaneously.

In yet another alternative embodiment, a single button 8 may be configured so that a single tap may send a single photograph to multiple recipients such as a pre-defined group of users or even multiple social networks. In this scenario, layer editor 220 may receive multiple entries of recipients and instruct button creator 240 to create a single button. In yet another scenario, locally predefined groups of recipients may also be used.

In an alternative embodiment, multiple photographs 15 may be taken and distributed to multiple recipients by taking the photographs 15 with the pertinent camera 30, saving them locally and then tapping on each button 8 individually to select a recipient. It will be appreciated that on each tap, button handler 20 may instruct distributer 50 to distribute the photographs to each recipient as described herein above.

In yet another alternative embodiment to the current invention, interaction layer 12 may be transferable to other applications to enable a user to share other forms of items also with a single tap over different platforms for messaging, picture messaging and other forms of communication. It will be appreciated that layer 12 may be presented over and may be used to quickly and automatically send different items and visual elements such as stamps, stickers, emotions, emoji's etc.as well as disappearing photographs, video, music clips, video stills, pre-defined text, documents, sounds etc. For example, if layer 12 is presented over the gallery of photographs belonging to user 5, user 5 may select a photograph and send it to a recipient using a pre-defined platform also with one tap. If layer 12 is presented over a playlist, user 5 may select a song to be sent.

In another embodiment, layer 12 may presented over an empty background. It will be appreciated that on receiving a tap, layer handler 25 may enable the local text input device and allow user 5 to enter his text. Once user 5 has finished entering his text, user 5 may tap on the relevant button 8 to send the text to his chosen recipient.

It will be appreciated that in this embodiment, button handler 20, instead of instructing camera 30 to take a photograph, may instead retrieve the pertinent item file to be distributed in an appropriate format from its source such as a local database, a network or 3^{rd} party database, the local operating system etc.

It will also be appreciated that the recipient of the item being sent may receive either a push notification or any other notification pertinent to the device in use that new item has been received as described herein above.

Thus a user may send a photograph or any other form of media to a pre-defined recipient through a single one tap action or any other combinations of multiple taps or gestures using interactive layer 12.

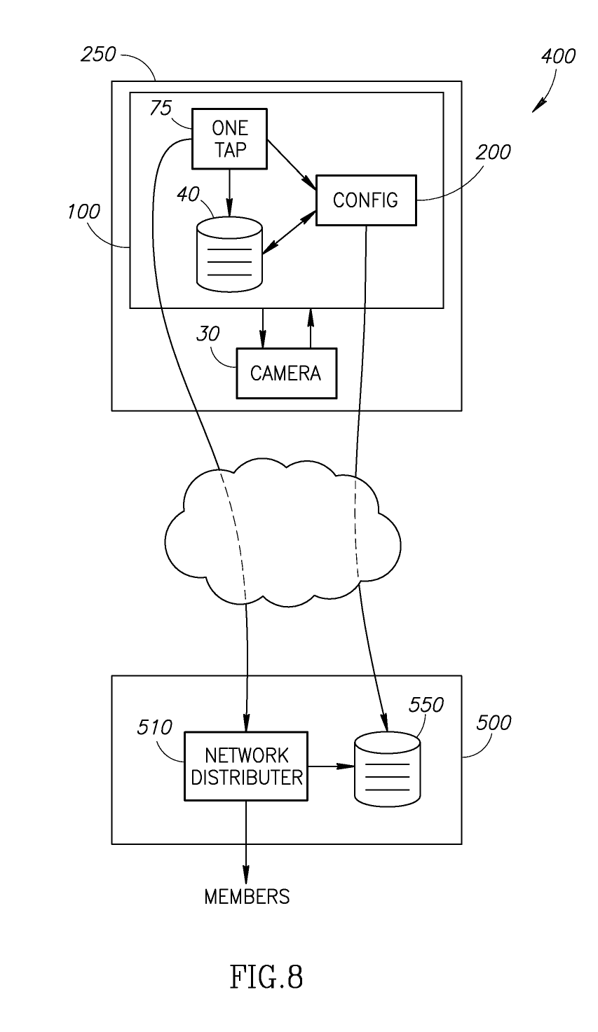

In an alternative embodiment to the present invention, recipients may not only be locally held contacts but also members of a community of users of device 100 whose contact details may be held in a separate database held on an external server. Reference is now made to FIG. 8 which illustrates a system 400 for sharing photographs via a community of users with a single tap. As is illustrated, device 100 may be installed locally on a client 250 and may communicate with a server 500 via a suitable communication medium such as the internet. It will be appreciated that user 5 may configure buttons 8 locally using configurer 200 as described herein above with the added option of selecting recipients held on member database 550. It will be members of the social network may be identified by a unique community username or by personal phone number. It will be further appreciated that user 5 may also save any configurations of buttons 8 or interaction layer 12 on a member database 550 for access by user 5 when he is away from client 250.

It will be appreciated that in this scenario when sending to a recipient via the social network, distributer 50 may send photograph 15 to network distributer 510 to forward to a fellow member via the social network. For example user 5 may send photograph 15 to a fellow member Jill who is registered on the social network and whose details are stored in database 550. Therefore when the appropriate button 8 is pressed and released, distributer 50 may send photograph 15 to network distributer 510. Network distributer 510 may then send photograph 15 to Jill via the pertinent program or platform and Jill may view photograph 15 via an appropriate photo viewer.

In another embodiment, recipients of photograph 15 via the social network as described herein above, may also respond to the received photograph 15 using icons or text. For example Jill may add an icon of a smiley face or a heart to photograph 15 and return it to user 5 as described in more detail herein below.

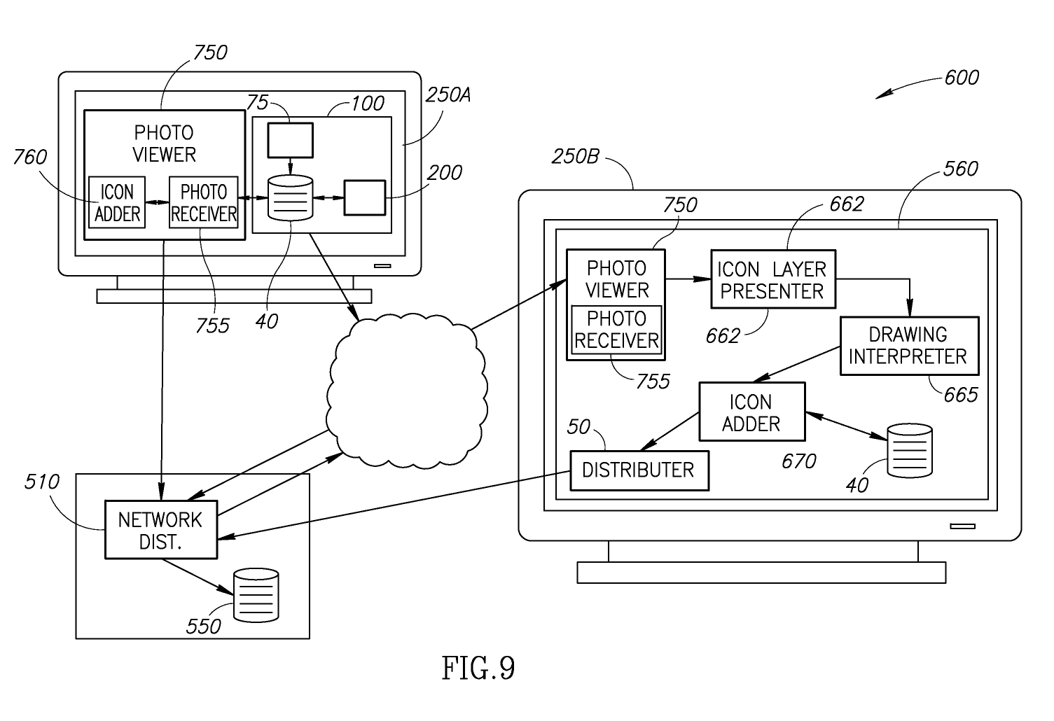

Reference is now made to FIG. 9 which illustrates a system 600 for sharing photographs with icons within a social network according to an embodiment of the present invention. System 600 may comprise photo sharer with icon 560 installed on client 250B and network distributor 510 and database 550 installed on server 500. Photo sharer with icon 560 may comprise photo viewer 750, icon layer presenter 662, drawing interpreter 665, icon adder 670, database 40 and distributer 50. Photo viewer 750 may comprise a photo receiver 755.

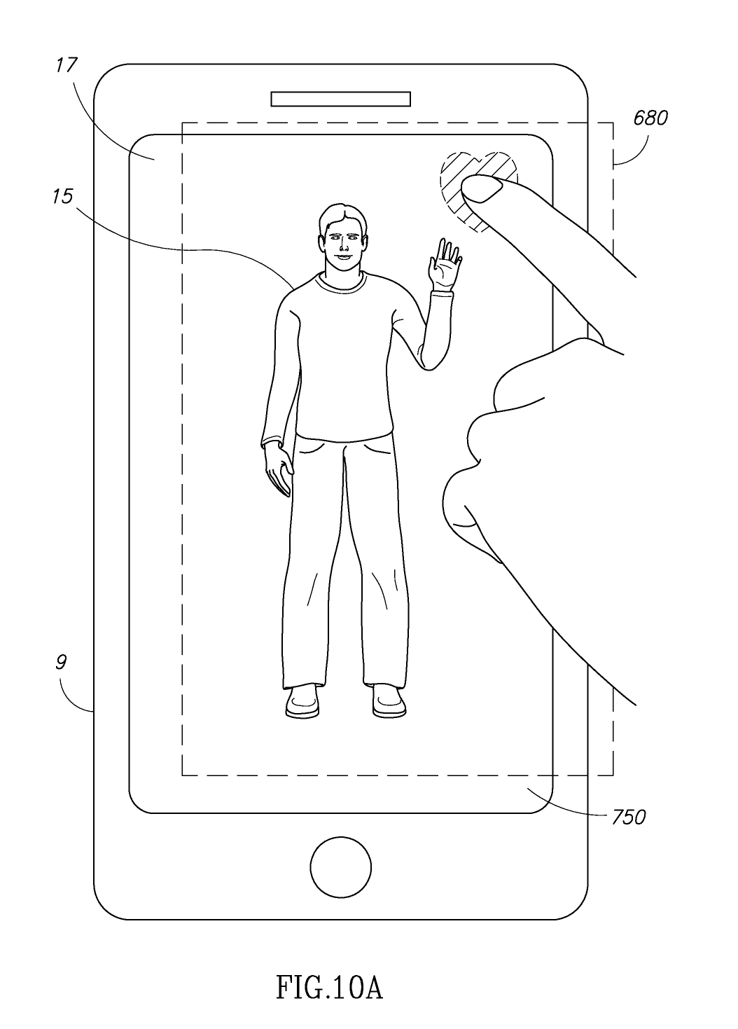

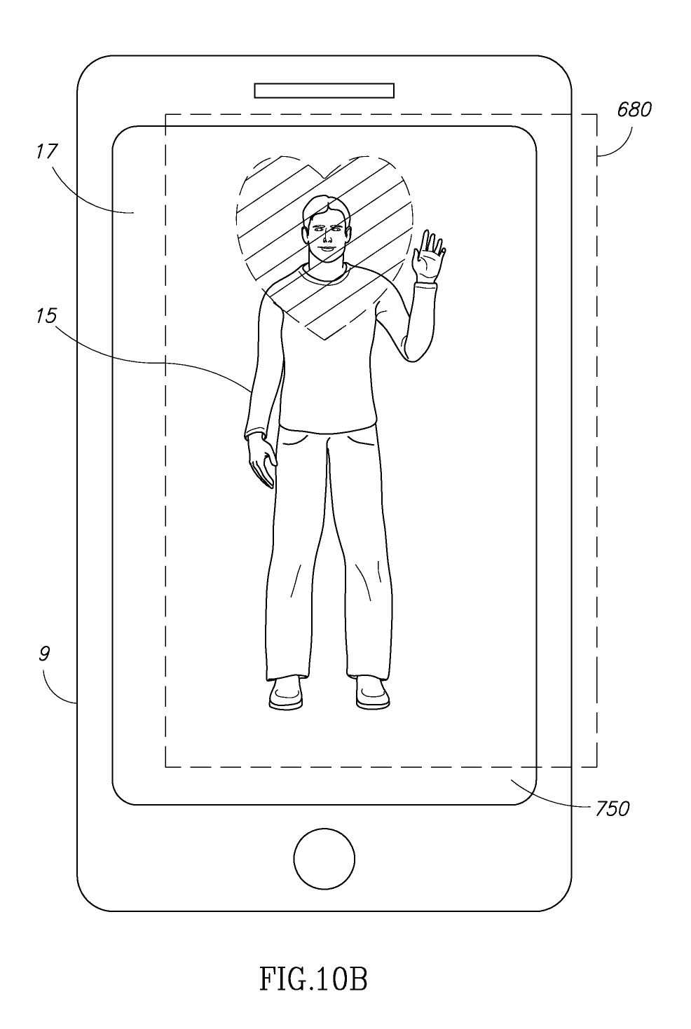

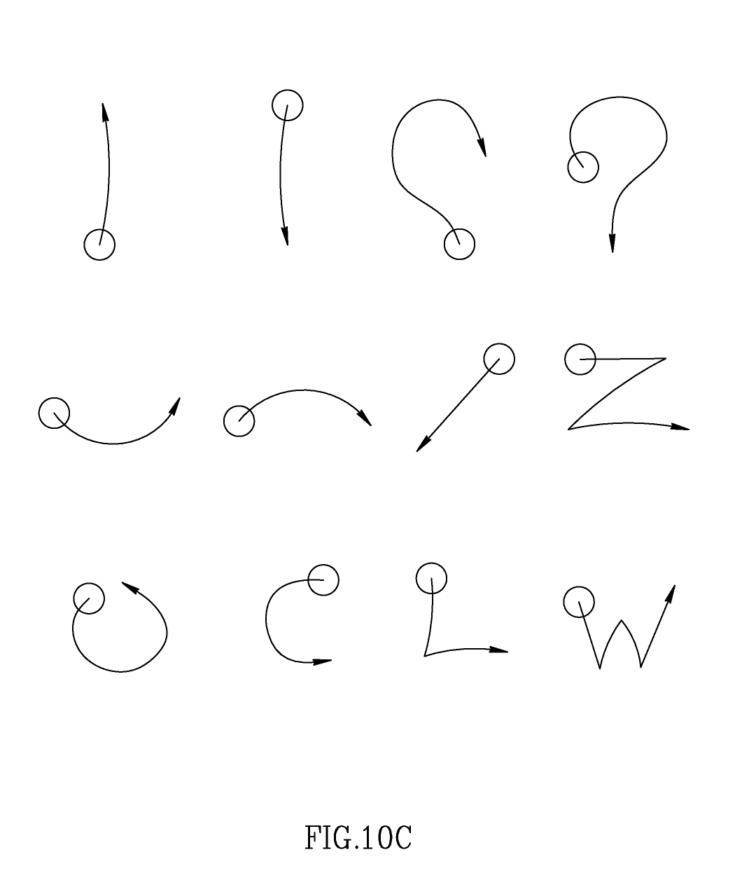

Photo receiver 755 may receive photograph 15 via network distributer 510. Jill sitting at client 250B may receive a push notification that she has received photograph 15 may then view photograph 15 via viewer 750 of her pertinent device. It will be appreciated that on viewing photograph 15, icon layer presenter 662 may present a transparent icon layer 680 over the viewer presentation screen 17 as is illustrated in FIG. 10A to which reference is now made. It will be appreciated that icon layer 680 may be invisible to Jill but may allow her to draw a drawing over photograph 15 using her finger, a stylus or any other input tool that may be used with a touch screen as is illustrated in FIG. 10A. The animation may correspond to an icon that she would like to send back to user 5 in response to the received photograph 15 such as heart, a smiley face or a thumbs-up. As Jill draws her animation, drawing interpreter 665 may interpret it using a recognition algorithm as described in more detail herein below providing a matching icon 700 to the drawing made. Icon adder 670 may then update layer 680 to include an embedded icon 700 and present it to Jill over photograph 15 as is illustrated in FIG. 10B to which reference is now made.

It will be appreciated that drawing interpreter 665 may calculate the movement of the finger or input device over interactive layer 680 and then, based on what is drawn as it is drawn, suggest a suitable icon 700 match for the drawing. It will be further appreciated that each suggestion may be based on rules concerning the direction of movement of the finger over interactive layer 680. For example, for a drawing of a smiley face, the recognized pattern may be the bottom half of a circle drawn from left to right. It will be further appreciated that the definition of what kind of arc or finger movement identifies a certain drawing may be defined by a pre-determined x, y and z scale definition of the coordinates.

It will also be appreciated, that drawing interpreter 665 may also use a priority calculation to prioritize certain drawings over others based on the movement of the finger over layer 680. For example, drawing interpreter 665 may recognize a parabola or arc drawn on layer 680 from left-to right, drawing interpreter 665as part of a smiley face and not as a heart This may also be based on the x, y and z scale of movement of the finger as described herein above.

It will also be appreciated that before she draws over layer 680, Jill may be provided with local instruction as to how to draw individual icons 700 to ensure that her drawings are recognized. For example, the arc for a smile may be drawn from left-to-right and not right-to-left as is illustrated in FIG. 10C to which reference is now made.

It will be appreciated that icon 700 may have an associated code that may be stored in database 40. Icon adder 670 may then instruct distributer 50 to return photograph 15 together with the associated code number to user 5 via server 500 and network distributer 550. It will be appreciated that if no match is found by drawing interpreter 665 the process may be stopped by drawing interpreter 665 and no photograph is returned to user 5.

Photo receiver 755 on client 250A may receive photograph 15 and the associated icon 700 code and user 5 may receive a push notification that he has received a message. Photo receiver 755 may retrieve from database 40, the graphic of icon 700 corresponding to the received associated code and may instruct icon adder 670 to recreate layer 680 containing icon 700 and to present to user 5, photograph 15 together with layer 680 as is illustrated in FIG. 10B.

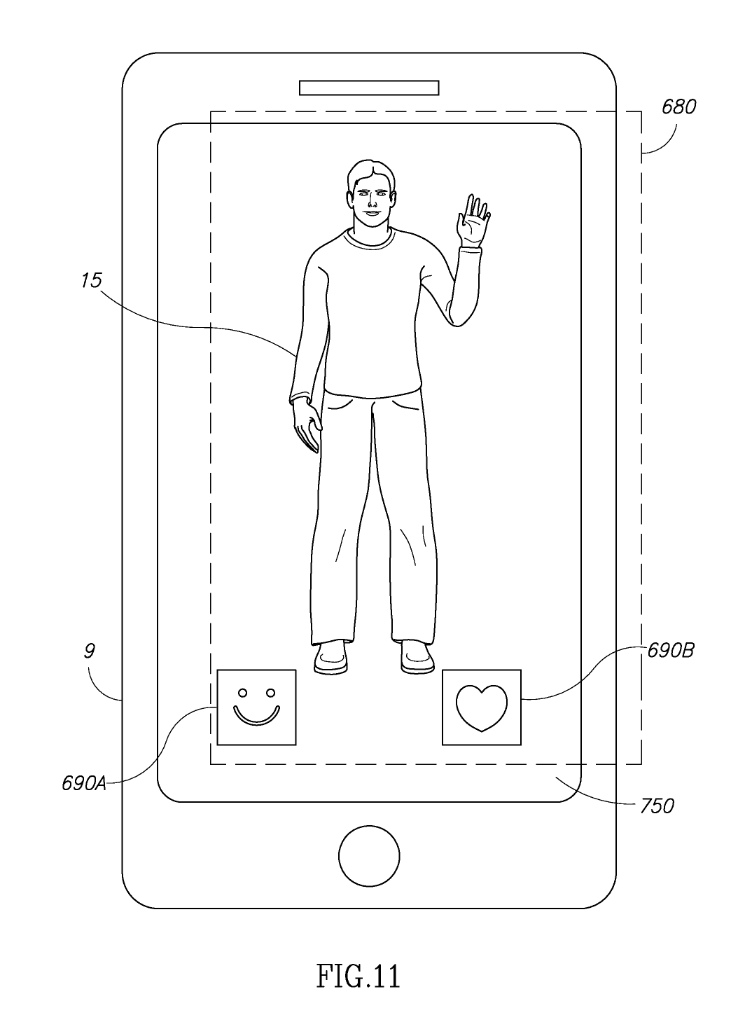

In an alternative embodiment, layer 680 may comprise icon buttons 690 as is illustrated in FIG. 11 to which reference is now made. Layer 680 containing icon buttons 690 may be presented to Jill when she views photograph 15 on viewer 750 as is described herein above.

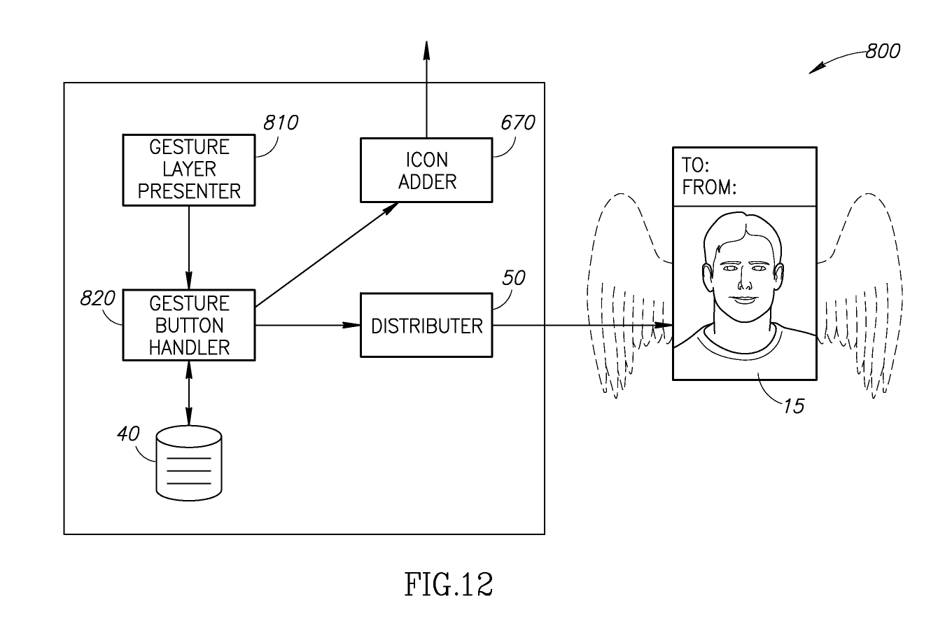

Reference is now made to FIG. 12 which illustrates a system 800 for sharing photographs with icons within a social network. System 800 comprises an icon layer presenter 810, an icon button handler 820, database 40 and distributer 50.

Icon layer presenter 810 may present to Jill layer 680. Jill may select the desired icon button 690 showing the icon 700 that she wishes to add to photograph 15. Icon button handler 820 may retrieve the associated graphic and code for icon 700 from database 40 and instruct icon presenter 830 to add the graphic of icon 700 to layer 680 and to present it to Jill. Icon button handler 820 may then instruct distributer 50 to return photograph 15 and the associated icon 700 code to user 5 as described herein above.

In another embodiment, text may be returned to user 5 in place of icon 700. In this case scenario layer presenters 662 and 810 may call the local text input device and icon adder 670 may add the text to layer 680 to be sent out by distributer 50.

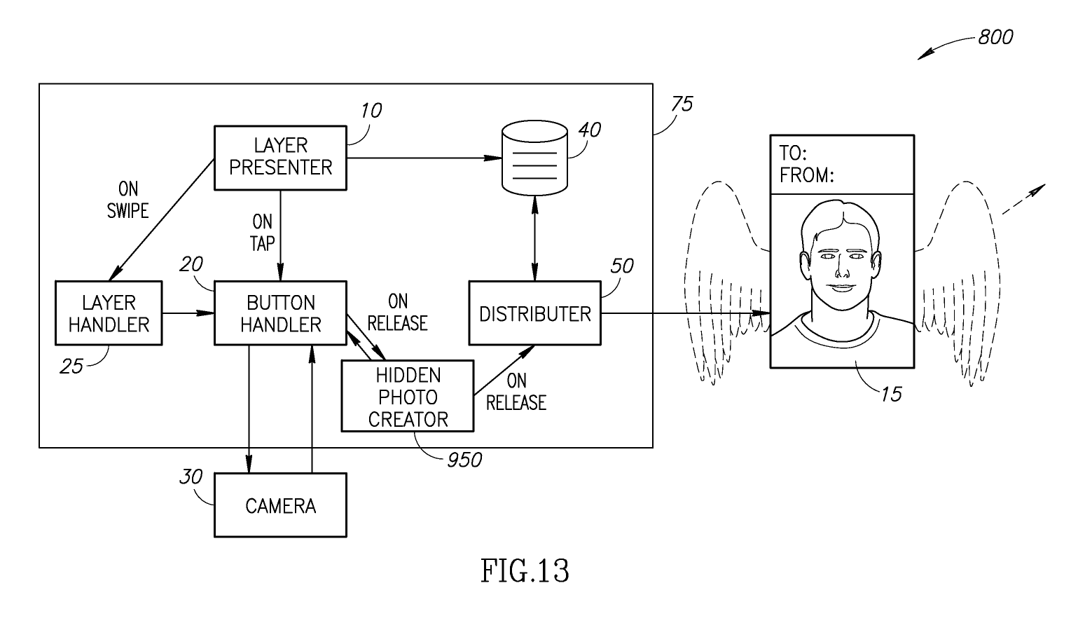

It will be also appreciated that device 100 may be used to send hidden photographs. Reference is now made to FIG. 13 which illustrates device 800 for sending hidden photographs in accordance with an embodiment of the present invention. Device 800 may be similar to device 100 with a hidden photo creator 950. A recipient such as Jill may receive what may appear to be a single photograph from user 5. As discussed herein above, photo receiver 755 may receive the hidden photograph and present it to Jill via photo viewer 750 as discussed herein above. A simple swipe over the photograph may cause the photograph to “dissolve” and reveal a secondary “hidden” photograph beneath. It will be appreciated that a pertinent button 8 may be created that when tapped, button handler 20 may instruct camera 30 to take a photograph and pass the received photograph to hidden photo creator 950. Button handler 20 may then instruct camera 30 to take a secondary photograph which is also forwarded to hidden photo creator 950. Once hidden photo creator 950 has received both photographs, it may superimpose them together and add the relevant effect such as “dissolve” or “explode” etc. Hidden photo creator 950 may then instruct distributer 50 to distribute the photographs as described herein above.

Thus a user may share his photographs via a one tap process to known contacts, strangers and via social networks. Recipients via a closed social network in may also comment and add gestures in the form of icons to shared photographs.

A user may also use an interactive layer to share different formats items with pre-defined recipients via pre-defined platforms.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

1. A device comprising:
an input mechanism to receive a touch;
an input handler to instruct an imaging unit of said device to take an image when said input mechanism is touched; and
a distributer to distribute said image according to pre-defined attributes associated with said input mechanism when said input mechanism is released.

2. The device of claim 1 and also comprising a configurer to configure said input mechanism.

3. The device according to claim 1 and also comprising a layer presenter to present an interaction layer over the viewer screen of said imaging unit and to present said input mechanism.

4. The device according to claim 1 wherein said input mechanism is a button.

5. The device according to claim 1 wherein said pre-defined attributes are at least one of target recipient and mode of communication.

6. The device according to claim 5 and wherein said target recipient is at least one of a local contact, a contact from a social network, unknown to the user of said device, a social network, a feed, a physical instruction and a group defined by geographical location.

7. The device according to claim 5 and wherein said mode of communication is at least one of an SMS, a MMS, an email and via a social network.

8. The device according to claim 1 and wherein said input handler comprises an effect adder to add an effect to said image.

9. The device according claim 8 wherein said effect is at least one of filtering color, adding animation, adding text, adding an icon, adding visual media type and creating a disappearing image.

10. The device according to claim 1 and wherein said touch is at least one of a tap and swipe.

11. An interactive layer implementable on a communication device, said interactive layer comprising:
a layer presenter to present said layer over a viewing screen of said communication device, said screen displaying an item;
at least one creatable input mechanism representing a recipient and a platform of communication;
a handler to receive and handle an instruction to send said item when said input mechanism receives an activation; and
a distributer to distribute said item to said recipient via said platform of communication.

12. The interactive layer according to claim 11 and also comprising pre-configured control buttons.

13. The interactive layer according to claim 11 and wherein said item is at least one of a single image, multiple images, text, documents, sound, video and icons.

14. The interactive layer according to claim 11 and wherein said handler comprises a retriever to retrieve said item from its source.

15. The interactive layer according to claim 11 and wherein said layer presenter comprises a displayer to display over part of said viewing screen of said device.

16. The interactive layer according to claim 11 and wherein said layer is at least one of transparent and translucent.

17. The interactive layer according to claim 11 and also comprising an icon adder to add an icon displayed by said creatable input mechanism to a secondary layer when said input mechanism is activated and to present said secondary layer over said interactive layer and said item.

18. The interactive layer according to claim 11 and wherein said activation is at least one of a tap, a swipe, a double tap, a tap without hold and a tap with hold.

19. A system for adding an icon to a shared image, said system comprising on a recipient side:
a recipient receiver to receive said image from a sender;
a layer presenter to present an interactive layer over said image, wherein said interactive layer receives a drawing drawn by a user on said interactive layer;
an interpreter to interpret said drawing as a pre-defined icon having an associated code; and
a distributer to return said image to said sender with said matched code.

20. The system according to claim 19 and also comprising on a sender side:
a sender receiver to receive said image and said code returned by said distributer,
a retriever to retrieve said icon from a local database according to said code; and
an icon adder to add said retrieved icon to a secondary layer and to present said secondary layer over said image.

21. The system according to claim 18 and wherein said interpreter comprises an analyzer to analyze the x, y and z coordinates said drawn animation.

22. The system according to claim 21 and wherein said interpreter comprises a prioritizer to prioritize said analysis of said drawing.

23. A method implementable on a computing device, said method comprising:
receiving a touch from an input mechanism;
instructing an imaging unit of said device to take an image when said input mechanism is touched; and
distributing said image according to pre-defined attributes associated with said input mechanism when said input mechanism is released.

24. The method of claim 23 and also comprising configuring said input mechanism.

25. The method according to claim 23 and also comprising presenting an interaction layer over the viewer screen of said imaging unit and presenting said input mechanism.

26. The method according to claim 23 wherein said input mechanism is a button.

27. The method according to claim 23 wherein said pre-defined attributes are at least one of target recipient and mode of communication.

28. The method according to claim 27 and wherein said target recipient is at least one of a local contact, a contact from a social network, unknown to the user of said device, a social network, a feed, a physical instruction and a group defined by geographical location.

29. The method according to claim 27 and wherein said mode of communication is at least one of an SMS, a MMS, an email and via a social network.

30. The method according to claim 23 and also comprising adding an effect to said image.

31. The method according claim 30 wherein said adding an effect is at least one of filtering color, adding animation, adding text, adding an icon, adding visual media type and creating a disappearing image.

32. The method according to claim 23 and wherein said touch is at least one of tapping and swiping.

33. A method implementable on a communication device, said method comprising:
presenting a layer over a viewing screen of said communication device, said screen displaying an item;
representing a recipient and a platform of communication on a creatable input mechanism;
receiving and handling an instruction to send said item when said input mechanism receives an activation; and
distributing said item to said recipient via said platform of communication.

34. The method according to claim 33 and also comprising pre-configuring control buttons.

35. The method according to claim 33 and wherein said item is at least one of an image, multiple images, text, documents, sound, video and icons.

36. The method according to claim 33 and wherein said handling comprises retrieving said item from its source.

37. The method according to claim 33 and wherein said presenting comprises displaying over part of said viewing screen of said device.

38. The method according to claim 33 and also comprising adding an icon displayed by said creatable input mechanism to a secondary layer when said input mechanism is activated and presenting said secondary layer over said interactive layer and said item.

39. The method according to claim 33 and wherein said activation is at least one of tapping, swiping, double tapping, tapping without hold and tapping with hold.

40. A method for adding an icon to a shared image, said method comprising on a recipient side:
receiving said image from a sender;
presenting an interactive layer over said image, wherein said interactive layer receives a drawing drawn by a user on said interactive layer;
interpreting said drawing as a pre-defined icon having an associated code; and
returning said image to said sender with said matched code.

41. The method according to claim 41 and also comprising on a sender side:
receiving said image and said code returned by said distributer,
retrieving said icon from a local database according to said code; and
adding said retrieved icon to a secondary layer and presenting said secondary layer over said image.

42. The method according to claim 41 wherein said interpreting comprises analyzing the x, y, and z coordinates of said drawn animation.

43. The method according to claim 21 and wherein interpreting comprises prioritizing said analysis of said drawing.
